(19) United States
(12) Patent Application Publication
(10) Pub. No.: US 2026/0077430 A1
(43) Pub. Date: Mar. 19, 2026

(54) JET CUTTING OF COMPONENTS FROM A SHEET-METAL PLATE TAKING INTO ACCOUNT INTERFERENCE CONTOURS DUE TO TILTING COMPONENTS

(71) Applicant: TRUMPF Werkzeugmaschinen SE + Co. KG, Ditzingen (DE)

(72) Inventors: Manuel KIEFER, Sinsheim (DE); Frederick STRUCKMEIER, Heimsheim (DE); Steffen SCHUHMANN, Vienna (AT); Johanna RÖCKER, Weil der Stadt (DE); Sascha BRANDT, Weil der Stadt (DE); Stefan KNAPP, Oberstenfeld (DE); Florian DOMMERT, Gerlingen (DE)

(21) Appl. No.: 19/396,369

(22) Filed: Nov. 21, 2025

Related U.S. Application Data
(63) Continuation of application No. PCT/EP2024/064660, filed on May 28, 2024.

(30) Foreign Application Priority Data
Jun. 2, 2023 (DE) 10 2023 114 514.2

(51) Int. Cl. B23K 26/14; B23K 26/38

(52) U.S. Cl. CPC B23K 26/14; B23K 26/38

(57) ABSTRACT

A method for cutting out components from a sheet-metal plate using a beam cutting machine that includes a workpiece support with support bars. The method includes specifying a nesting plan of the components, a machining program for controlling a cutting head, and tolerance fields of a width for grid positions of the support bars, acquiring the grid positions of the support bars and a position of the sheet-metal plate, determining where the support bars are located relative to the sheet-metal plate, calculating sets of interference contours which result from the components tilting on the support bars, determining a set of effective interference contours from the sets of interference contours, changing the machining program so that a distance between the cutting head and the interference contours of the components already cut free does not fall below a predetermined minimum distance, and cutting out the components according to the changed machining program.

### CROSS REFERENCE TO RELATED APPLICATIONS

This application is a continuation of International Application No. PCT/EP2024/064660 (WO 2024/246068 A1), filed on May 28, 2024, and claims benefit to German Patent Application No. DE 10 2023 114 514.2, filed on Jun. 2, 2023. The aforementioned applications are hereby incorporated by reference herein.

### FIELD

Embodiments of the present invention relate to a method for cutting out components from a sheet-metal plate using a beam cutting machine with a cutting head, wherein the beam cutting machine has a workpiece support with multiple support bars for the sheet-metal plate, wherein the support bars can be arranged at predetermined grid positions.

### BACKGROUND

Such methods and beam cutting machines are generally known, for example from DE 10 2019 126 403 A1 or DE 10 2019 104 649 B4. Laser cutting machines with a laser cutting head are often used.

For laser cutting of (sheet-metal) components, so-called flatbed machines are used in particular, in which a sheet-metal plate rests on a workpiece support with multiple spaced-apart support bars. The support bars can have protruding tips for locally limited contact with the sheet-metal plate. The components are cut out by moving a laser cutting head relative to the workpiece support with the sheet-metal plate. Due to the point or line-like support, via the support bars arranged at a distance from one another, it is possible that individual cut-out components tilt, depending on the size of the cut-out components and their position relative to the support bars. There is then a risk of the laser cutting head colliding with the raised region of the component. This can lead to damage to the laser cutting machine and/or the components. Manual intervention may also be required in order to continue production.

The patent DE 10 2019 104 649 B4 mentioned at the outset relates to a method for acquiring the position of at least one support bar in an arrangement of support bars of a pallet. The pallet is intended for use with a flatbed machine tool, in particular a laser cutting or punching flatbed machine tool. According to the method, the pallet is illuminated with spatially structured light. The positions of the support bars in relation to a raw material sheet can also be determined and the shapes of the workpieces to be cut out can be arranged (nested) on the raw material sheet according to certain parameters with reference to the support bars and cut out from it. Taking into account the arrangement of support bars in relation to the raw material sheet makes it possible, for example, to avoid irradiation paths extending over supporting surfaces of the support bars so that the support bars are less exposed to the laser beam and less likely to be damaged. Furthermore, tilting movements of larger components, for example, can be avoided by supporting them in a targeted manner at stable points on the support bars. In this regard, DE 10 2019 104 649 B4 does not describe which specific measures are carried out in detail.

DE 10 2019 126 403 A1, which has also already been mentioned at the outset, describes a method for loading a sheet depositing device of a flatbed machine tool with a material sheet, wherein the material sheet is to be fed for machining with the flatbed machine tool originating from a target position assigned to the machining in a machine coordinate system and the flatbed machine tool comprises a camera system with at least one camera. The camera system is designed to record images of the sheet depositing device that are spatially calibrated with respect to the machine coordinate system of the flatbed machine tool. The method comprises the steps of:
recording an image of the material sheet in the region of the sheet depositing device,
evaluating the image acquisition to determine an actual sheet position in the machine coordinate system,
acquiring a deviation of the determined actual sheet position from the target position and using the acquired deviation to align and position the material sheet.

A control system of the flatbed machine tool, in particular a laser control system, can detect the actual (current) position (e.g. if it is within the tolerance range) and adapt a corresponding machining program (e.g. the cutting plan) to the actual position by means of transformation. The target position can be predetermined manually in accordance with DE 10 2019 126 403 A1 or calculated on the basis of the support bar configuration on the laser flatbed machine at the time of loading. Furthermore, the target position can be determined on the basis of part nesting on the material sheet, in particular depending on parameters such as avoidance of tilting parts, optimal support of the parts during the cutting process, avoidance of slag splatter and avoidance of welding of parts to the base layer. Furthermore, the nesting of the parts to be created can be subsequently adapted, in particular optimized, on the basis of the loading position and the support bar configuration. This can also be done on the basis of parameters such as avoiding tilting parts, optimal support of the parts, e.g. during the cutting process, avoidance of slag splatter and avoidance of welding of parts to the base layer. In DE 10 2019 126 403 A1, the specific measures in this regard remain unexplained once again.

### SUMMARY

Embodiments of the present invention provide a method for cutting out components from a sheet-metal plate using a beam cutting machine with a cutting head. The beam cutting machine includes a workpiece support with multiple support bars for the sheet-metal plate. The support bars are capable of being arranged at predetermined grid positions. The method includes specifying a nesting plan of the components to be cut out on the sheet-metal plate, a machining program for controlling the cutting head during the cutting out of the components arranged according to the nesting plan from the sheet-metal plate, and tolerance fields of a predetermined width for the grid positions of the support bars. The method further includes acquiring the grid positions at which the support bars are present, and a position of the sheet-metal plate arranged on the workpiece support. The method further includes determining where the support bars are located relative to the sheet-metal plate, and calculating sets of interference contours which result from the components of the predetermined nesting plan tilting on the support bars. Each respective set of interference contours is calculated for a plurality of the grid positions of the support bars within the tolerance fields. The method further includes determining a set of effective interference contours from the calculated sets of interference contours, changing the machining program so that a distance between the cutting head and the interference contours of the components already cut free during execution of the changed machining program does not fall below a predetermined minimum distance for the set of effective interference contours, and cutting out the components according to the changed machining program.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a beam cutting machine according to embodiments of the invention with a workpiece support on which a sheet-metal plate is arranged, wherein the workpiece support is in a loading position and is acquired by a camera, in a schematic perspective view;

FIG. 2 shows a detail of the beam cutting machine of FIG. 1 with a workpiece support in a machining position and a movable cutting head, wherein a support bar is missing at a grid position of the workpiece support, in a schematic sectional view;

FIG. 3 shows the workpiece support of the beam cutting machine of FIG. 2, wherein it is shown that the positions of the support bars can vary within certain limits at the respective grid positions, in a schematic sectional view;

FIG. 4 shows a sheet-metal plate with a nesting plan of components to be cut out, in a schematic top view;

FIG. 5 shows a component resting in a stable manner on three support bars, in a schematic side view;

FIG. 6 shows the component of FIG. 5, wherein due to a displacement of the support bars relative to one another and of the component relative to the support bars, the component tilts, with representation of a resulting interference contour, in a schematic side view;

FIG. 7 shows a schematic flow diagram of a method according to embodiments of the invention for cutting out components from a sheet-metal plate; and

FIG. 8 shows a convex envelope of interference contours of a component that tilts in different ways depending on the support bar position, in a schematic side view, according to some embodiments.

### DETAILED DESCRIPTION

Embodiments of the invention can increase the process reliability when beam cutting sheet-metal parts and, in particular, to avoid collisions of a cutting head in an efficient manner.

According to embodiments of the invention, a method for cutting out components from a sheet-metal plate using a beam cutting machine with a cutting head is provided. In particular, the beam cutting machine is a laser cutting machine with a laser cutting head. The beam cutting machine has a workpiece support with multiple support bars for the sheet-metal plate, wherein the support bars can be arranged at predetermined grid positions. The cutting head can be moved relative to the workpiece support in order to cut out the components. Generally speaking, a support bar is arranged at most grid positions, typically at least 90% of the grid positions, but not necessarily at all grid positions of the workpiece support. The support bars can each have a plurality of tips for locally supporting the sheet-metal plate. Typically, the support bars extend in a straight line and the grid positions are aligned parallel to one another.

The method comprises the following steps:
A) specifying
i) a nesting plan of components to be cut out on the sheet-metal plate,
ii) a machining program, for controlling the cutting head during the cutting out of components arranged according to the nesting plan from the sheet-metal plate,
iii) tolerance fields of predetermined width for the positions of the support bars;
B) acquiring
i) the grid positions at which a support bar is present,
ii) a position of a sheet-metal plate arranged on the workpiece support;
C) determining where the support bars are located relative to the sheet-metal plate, in particular relative to the individual components to be cut out;
D) calculating sets of interference contours which could result from components of the predetermined nesting plan tilting on the support bars, wherein a set of interference contours is calculated in each case for a plurality of positions of the support bars within their respective tolerance fields;
E) determining a set of effective interference contours from the calculated sets of interference contours;
F) changing the machining program so that the distance between the cutting head and the interference contours of the components already cut free during execution of the changed machining program does not fall below a predetermined minimum distance for the set of effective interference contours;
G) cutting out the components according to the changed machining program.

The nesting plan describes the position of the components to be cut out on the sheet-metal plate. When executing the machining program, the components would be cut out according to the nesting plan. For this purpose, the machining program defines a relative movement of the cutting head and workpiece support. The nesting plan of the components can be implicitly predetermined by the machining program.

In practice, the support bars are often not arranged exactly at the grid positions. The actual position of a support bar may deviate from the grid position, for example due to deformation. For example, support bars may be bent or worn. Holders for the support bars can also be deformed or exhibit a certain amount of play. Regardless of the underlying mechanism, it is therefore possible that one or more of the support bars does not extend to the intended (target) position, but in an area around it. The maximum expected deviation from the target position is described by the width of the tolerance field. It is therefore assumed that the support bar is within the tolerance field at the respective grid position. In other words, it is assumed that the support bars are within the tolerance field of the predetermined width with respect to the respective grid position. Typically, the tolerance fields are the same size for all grid positions.

With interchangeable support bars in particular, it is not to be regarded as a certainty that there is actually a support bar at every grid position. The grid positions at which support bars are present are therefore acquired. Due to the predetermined tolerance field, the position of each support bar does not need to be determined exactly, but it is sufficient to recognize at which grid positions a support bar is arranged.

The position of the sheet-metal plate on the workpiece support can also vary. Therefore, the position of the sheet-metal plate relative to the workpiece support is also acquired.

The grid positions of the support bars and/or the position of the sheet-metal plate can be acquired by means of a camera. The camera can be arranged on a housing part of the beam cutting machine. The grid positions of the support bars and/or the position of the sheet-metal plate can be acquired by means of a sensor device. The sensor device can be arranged on a housing part of the beam cutting machine. The sensor device can use radar, lidar, ultrasound, laser light sheet, inductive or capacitive measuring methods for this purpose. The sensor device and/or the camera can be guided in a movable manner by means of a holding device.

The previously determined data on the presence of the support bars and the position of the sheet-metal plate on the workpiece support is used to determine the points at which the sheet-metal plate is supported by the support bars. In particular, it is determined where the components arranged in the nesting plan are supported by the support bars.

Depending on the size and position of a component, it may tilt around one of the support bars after it has been cut free (completely cut out). This can result in an interference contour. The interference contour describes in particular that region above the workpiece support into which a tilted or tilting component can protrude. In particular, the component can remain in a tilted position and protrude above the support surface of the workpiece support. The interference contours can be calculated as rotational bodies of the tilting components. It can be assumed that a component will tilt if its center of gravity is located beyond an external support bar on the component in question; otherwise, it can be assumed that the component will not tilt, so that no interference contour is created. A component that is only supported by a single support bar will usually tilt.

Since the positions of the support bars can vary as explained above, the interference contours of the potentially tilting components are calculated for a plurality of different positions of the support bars within their respective tolerance fields. The positions of the support bars can be varied in predetermined increments within the tolerance fields, for example. In particular, at least five positions can be checked mathematically for each support bar. In this regard, it is expedient to include the limits of the tolerance fields. Preferably, all combinations of positions of the support bars within their respective tolerance field are checked successively (for the selected number of positions per tolerance field) for potential interference contours. In this way, a set of interference contours is determined for each combination of support bar positions under consideration.

From the many sets of interference contours, a set of effective interference contours is determined, in which information from the individual sets is aggregated in a predetermined manner. The set of effective interference contours is also referred to as the effective set of interference contours.

The set of effective interference contours can be determined from the calculated sets according to a predetermined criterion. In particular, the calculated interference contours of multiple sets can be superimposed in the effective set. For each potentially tiltable component, the interference contours with the largest volume and/or the largest height, depending on the position of the support bars, can be included in the effective set of interference contours.

Based on the set of effective interference contours, the machining program is changed so that the cutting head does not cross the regions of potential interference contours. The machining program is adapted in such a way to this end that a minimum distance is always maintained between the cutting head and the interference contours of the components that have already been cut free in the changed machining process. It should be noted that before a component is completely cut out (cut free), the region of its potential interference contour can be traversed, as only components that have been cut free can tilt.

Finally, the components are cut out with execution of the changed machining program. The change to the machining program described above reduces disruptions, in particular collisions, during the cutting-out process of the components.

Overall, the method according to embodiments of the invention increases productivity thanks to a cutting process without disruptions and collisions as well as unplanned downtimes of the beam cutting machine. In particular, less machine wear can also be achieved by avoiding nozzle collisions and reducing wear on the support bars. In addition, consequential damage to the cutting head, a movement unit or bellows, for example, is avoided. The risk of injury during cutting operations is also reduced, as less frequent collisions reduce the need for manual interventions with respect to the machine. Furthermore, operating personnel are no longer permanently required at the beam cutting machine. Downstream processes such as automatic unloading also benefit from the targeted prevention of tilting. In addition, the effort required for fine-tuning the machining program can be reduced in upstream processes for order planning and CAD/CAM programming. Finally, the increase in cutting stability increases confidence in the cutting process. Overall, unplanned downtimes are reduced, resulting in greater economic efficiency.

Steps A) and B) as well as sub-steps i) to iii) or i) and ii) of steps A) or B) can each be carried out in any order and/or at least in part simultaneously.

During the execution of steps C) to F), set-up processes or maintenance measures can be carried out on the beam cutting machine.

The method according to embodiments of the invention is preferably carried out using a beam cutting machine according to embodiments of the invention as described below.

The workpiece support is movable between a loading position and a machining position. This makes it easier to arrange the sheet-metal plate on the workpiece support.

Preferably, the grid positions of the (present) support bars and/or the position of the sheet-metal plate are acquired when the workpiece support is in the loading position. The workpiece support is then usually easy to see, for example using a camera. In addition, the time required for moving the workpiece support into the machining position can be used to carry out the other method steps.

Preferably, steps D), E) and F) are carried out at least in part while the workpiece support is moved from the loading position to the machining position. This reduces the time until the beam cutting machine can start cutting out the components after the sheet-metal plate has been placed.

In particular, the start of step G) can be delayed after reaching the machining position until steps D) to F) have been completed. In order to maximize machine utilization, the conventional approach is to avoid downtimes as far as possible. However, the method according to embodiments of the invention can reduce operational interruptions during cutting to such an extent that a certain delay in the start of machining results in an overall reduction in production time or higher productivity.

Preferably, in step D), the sets of interference contours are furthermore calculated for different positions of the sheet-metal plate within a predetermined region relative to the acquired position of the sheet-metal plate. Potential interference contours are thus determined for various positions of the sheet-metal plate in the predetermined region around the acquired position and the various positions of the support bars. In this way, inaccuracies in acquiring the position of the sheet-metal plate can be compensated for.

The set of effective interference contours can correspond to the calculated set of interference contours having a largest volume of the interference contours above the sheet-metal plate and/or a maximum height of the interference contours. A worst-case scenario is therefore assumed for adapting the machining program.

Alternatively, the set of effective interference contours can correspond to an envelope contour of the interference contours of multiple calculated sets, in particular all calculated sets, of interference contours. In this way, multiple, preferably all, potentially occurring interference contours are used to adapt the machining program. The envelope contour can be a convex envelope of the calculated interference contours.

In step F), multiple changed variants of the machining program can be determined and one of the variants can be selected according to a predetermined criterion. This allows for a machining program to be obtained that has been optimized in a particularly effective manner. At the same time, only a few specifications or preliminary information are required to determine the variants of the machining program, as less good variants are sorted out and an advantageous variant is selected instead. The criterion can include, for example, maximizing an integral of the distance between the cutting head and the interference contours of the components that have already been cut free. The criterion can relate to the point in time in the execution of the machining program at which a component that represents a potential interference contour is cut free. In particular, a variant of the machining program can be selected in which potential interference contours are created as late as possible in the execution of the machining program.

In step F), a sequence in which the components and/or partial contours of the components are cut out can be changed. Collisions with potentially tilting components can be avoided particularly easily and effectively in this manner. In particular, larger components, for example, may not be cut free in one piece, but successively along multiple partial contours. Smaller components that fall down between the support bars after being cut free can be cut out in a determined time range, preferably at the beginning of the machining program, and removed via a conveyor system below the workpiece support. The conveyor system can be a (scrap) conveyor belt that is chronologically synchronized to the accumulation of small components or scrap pieces.

In step F), the course of the travel paths can be changed for positioning movements without a cutting operation, in particular so that components which have already been cut free are bypassed. Alternatively or additionally, the distance between the cutting head and the sheet-metal plate can be increased and/or the cutting gas pressure reduced above components that have already been cut free. These measures can also effectively reduce the risk of collision in a simple way, usually at the expense of a slightly longer machining time. As a rule, the aim is to reduce the length of travel paths over cut free components, i.e., to avoid them as far as possible. If it is not possible to avoid them by altering the course, the other measures mentioned can be taken.

In step F), additional cutting of scrap pieces can be provided for. The scrap pieces are thus cut up in step G). The respective partial pieces of one of the scrap pieces can fall between the support bars and be disposed of, for example, via a conveyor system below the workpiece support, such as a (scrap) conveyor belt.

In step F),
positions of connections of the components provided for in the predetermined machining program with respect to the scrap skeleton of the sheet-metal plate can be changed, and/or
connections of the components with respect to the scrap skeleton of the sheet-metal plate provided for in the predetermined machining program can be removed, and/or
additional connections of the components with respect to the scrap skeleton of the sheet-metal plate can be inserted.

These connections or joints are also referred to as “micro-joints” or “nano-joints” and are subsequently separated (typically outside of the machining region), for example manually or by an unloading system. The aforementioned changes allow these connections to be provided in the number necessary to avoid tilting components, wherein connections beyond this are avoided.

In step F), the nesting plan of the components on the sheet-metal plate can be changed. For this purpose, individual components can be displaced and/or rotated on the sheet-metal plate, typically within predetermined limits. In particular, the components can be placed in such a way that they do not tilt on the support bars. In this way, collisions between the cutting head and tilted components can be effectively and easily avoided.

In particular, the nesting plan can be changed in such a way that the length of cutting paths above support bars is reduced. This reduces the wear on the support bars caused by the cutting beam.

The machining program can be changed in step F) so that piercing processes in the region of support bars are reduced, preferably avoided. The position of the piercing point relative to one of the components can be changed for this purpose. Alternatively or additionally, this can be achieved by changing the nesting plan (i.e., changing the position and/or alignment of at least one of the components on the sheet-metal plate). When piercing over support bars, there is a risk that the piercing process will not proceed as desired. In addition, wear on the support bars is reduced due to the piercing process. The region of a support bar typically comprises the tolerance field at its grid position. An additional safety distance relative to the edge of the tolerance field can be predetermined.

In the event of a collision of the cutting head with the sheet-metal plate, with one of the components or with a scrap piece during the execution of step G), steps B)ii) to F) can be performed again and then step G) can be continued for the remaining cutting operations with the machining program changed again. In the event of a collision, the sheet-metal plate can displace on the workpiece support. This is compensated for by carrying out the aforementioned steps again. In order to carry out step B)ii) again, the workpiece support can be moved to the loading position.

Also within the scope of the present invention is a beam cutting machine with a cutting head, in particular a laser cutting machine with a laser cutting head, having
a workpiece support with multiple support bars for the sheet-metal plate, wherein the support bars can be arranged at predetermined grid positions;
a device, in particular a camera, for acquiring the grid positions at which a support bar is present, and for acquiring a position of a sheet-metal plate arranged on the workpiece support; and
a control device for controlling the cutting head,
   wherein a nesting plan of components on a sheet-metal plate, a machining program for cutting out the components from the sheet-metal plate and a width of tolerance fields for the positions of the support bars can be stored in the control device, and
   wherein the control device is designed (programmed) to carry out the steps B) to G) of a method according to any one of the preceding claims.

The beam cutting machine enables the method according to embodiments of the invention to be carried out in accordance with the nesting plan, the machining program and the tolerance field widths. The nesting plan can be implicitly defined by the machining program.

The beam cutting machine can have further features described in connection with the method according to embodiments of the invention.

In order to carry out step B), the control device can use the acquisition device (the camera). In order to carry out step G), the control device controls the cutting head according to the changed machining program. The workpiece support is movable between a loading position and a machining position.

The control device can be a local control device of a single beam cutting machine. Alternatively, the control device can be a central control device for a plurality of beam cutting machines. It is also conceivable that the control device is distributed between local and central control components.

According to embodiments of the invention, the features mentioned above and those yet to be explained further may be used in each case individually or together in any desired expedient combinations.

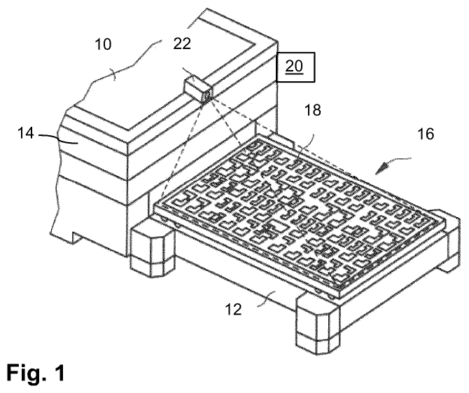

FIG. 1 shows a beam cutting machine in the form of a laser cutting machine 10. A workpiece support 12 is located in a loading position outside of a housing 14. A sheet-metal plate 16 is arranged on the workpiece support 12, wherein a nesting plan of components 18 to be cut out is drawn on the sheet-metal plate 16 in FIG. 1. In practice, the nesting plan is typically not shown on the sheet-metal plate 16, but is stored in a control device 20. A camera 22 acquires the workpiece support 12 and the sheet-metal plate 16. Here, the camera 22 is mounted on the housing 14.

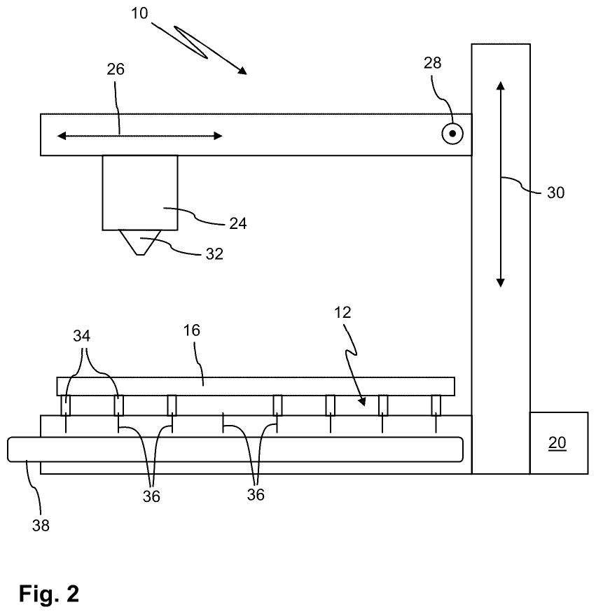

In FIG. 2, the workpiece support 12 is in a machining position inside of the housing 14 (not shown in FIG. 2, cf. FIG. 1). A laser cutting head 24 is movable along three axes 26, 28, 30 above the workpiece support 12. The laser cutting head 24 can have a nozzle 32, from which a laser beam and a cutting gas jet emerge to cut out the components 18.

FIG. 2 shows that the workpiece support 12 has multiple support bars 34 extending in a substantially parallel manner to one another; the support bars 34 here each extend perpendicular to the drawing plane. The support bars 34 can have tips, not shown in detail, for establishing a point contact with the sheet-metal plate 16. The support bars 34 are interchangeably arranged at a distance from one another at predetermined grid positions 36. It is possible that there is no support bar 34 present at one or more of the grid positions 36. In FIG. 2, for example, the support bar is missing at the fourth grid position from the left. The grid positions 36 can be defined by holders for the support bars 34.

A conveyor belt 38 can be arranged below the support bars 34. The conveyor belt 38 can be used to discharge small components or scrap pieces that have fallen through between the support bars 34.

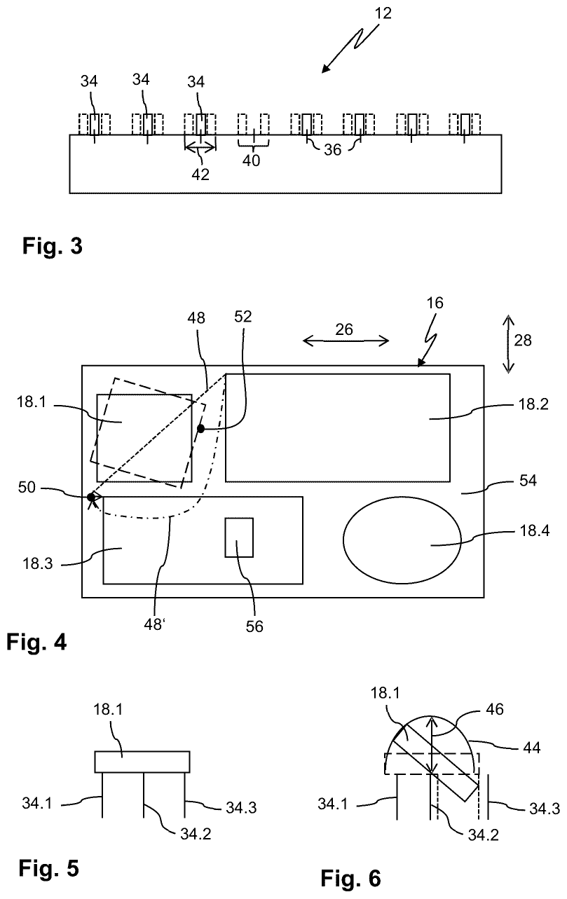

FIG. 3 illustrates that the actual position of a respective support bar 34 at its grid position 36 can vary within certain limits. This may be due to deformation, damage or play in the holders, for example. The possible positions of the support bars 34 can be described by tolerance fields 40, which have a determined width 42 depending on the type of workpiece support 12 and support bars 34. In FIG. 3, the outermost positions of a support bar 34 within its respective tolerance field 40 are shown as dashed lines in each case.

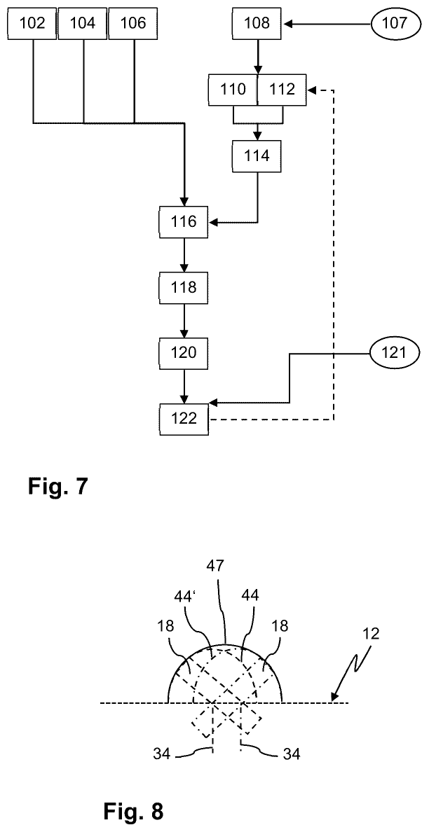

A method for cutting out the components 18 from the sheet-metal plate 16 is described with additional reference to the flow diagram shown in FIG. 7 and the nesting plan of FIG. 4 with four exemplary components 18.1-18.4.

First, a nesting plan is predetermined (step 102); the arrangement of the components 18.1-18.4 according to the original nesting plan is shown in FIG. 4 with solid lines. In addition, a machining program is specified (step 104), which controls the laser cutting machine 10 to cut out the components 18.1-18.4 according to the predetermined nesting plan. The nesting plan can be defined implicitly by the machining program or laid down separately. The nesting plan can be defined relative to the sheet-metal plate 16 or alternatively relative to the workpiece support 12. The machining program and the nesting plan are stored in the control device 20. In addition, the widths 42 for the tolerance fields 40 are predetermined (step 106) and stored in the control device 20.

While the workpiece support 12 is in the loading position (cf. FIG. 1), the sheet-metal plate 16 is placed on the workpiece support 12 (step 108). For this purpose, the workpiece support 12 may have been moved to the loading position in a step 107. Typically before or, in special cases, after placing the sheet-metal plate 12, the camera 22 is used to acquire at which grid positions 36 a support bar 34 is actually located (step 110). In addition, the camera 22 acquires where the sheet-metal plate 16 is located on the workpiece support 12 (step 112). Instead of the camera 22 or in addition to it, tactile and/or opto-electronic sensors such as light barriers could, for example, also be provided for acquiring the positions of the support bars 34 and the sheet-metal plate 16 (not shown in detail). From this information, it is determined in a step 114 where the sheet-metal plate 16 is located relative to the workpiece support 12, in particular relative to the grid positions 36. Steps 110 and 112 are also carried out in the exemplary embodiment shown while the workpiece support 12 is in the loading position.

The originally predetermined machining program can, for example, provide for the components to be cut out in the sequence 18.1, 18.2, 18.3 and 18.4, cf. FIG. 4.

When the support bars 36 and the sheet-metal plate 16 are in their target positions, the component 18.1 may be supported by three support bars 34.1-34.3 as shown in FIG. 5. If, on the other hand, the sheet-metal plate 16 with the component 18.1 is oriented in a manner slightly displaced (here to the left) on the workpiece support 12 and the support bar 34.2 is displaced towards the support bar 34.1 and the support bar 34.3 is displaced away from the support bars 34.1 and 34.2, the situation shown in FIG. 6 may occur, in which the component 18.1 is only supported by the two support bars 34.1 and 34.2, but not by the support bar 34.3. Furthermore, as the center of gravity of component 18.1 lies between support bars 18.2 and 18.3, the component 18.1 would tilt after being cut free. This can create an interference contour 44 with a height 46.

Interference contours could also arise in a similar way for the other components 18.2-18.4 and/or other displacements of the support bars 34. In a step 116, it is therefore calculated for different positions of each support bar 34 within its tolerance field 40 and preferably for different positions of the sheet-metal plate 16 relative to the workpiece support 12, which components 18 in the respective configuration can potentially tilt after being cut free. In particular, the shape of the interference contour 44 potentially created when tilting and its possible height 46 can be calculated. In this way, a set of interference contours 44 is obtained for each of the combinations of the different support bar positions within the respective tolerance fields 40 and the different positions of the sheet-metal plate 16.

The information on the interference contours 44 of the various sets is summarized in a step 118 into a set of effective interference contours (hereinafter also referred to as an effective set).

For each component 18 or 18.1-18.4, the maximum height 46 of its potentially resulting interference contour 44 can be stored in the set of effective interference contours. Alternatively or additionally, a maximum volume of a potentially resulting interference contour 44 can be stored for each component 18 or 18.1-18.4 in the effective set.

In the effective set of interference contours, an envelope contour 47 of the interference contours 44, 44′potentially resulting for the respective component can be stored as an effective interference contour for each component 18 or 18.1-18.4, cf. FIG. 8. FIG. 8 shows for the same component 18 that this component 18 can tilt in a different way depending on the assumed position of a support bar 34 (shown as dashed or dotted). The respective interference contours 44 or 44′ above the workpiece support 12 can be enclosed by the envelope contour 47 in the smallest convex space; in other words, the envelope contour 47 can be the convex envelope of the interference contours 44.

For components that are not expected to tilt in all configurations considered, corresponding information can be stored in the effective set.

On the basis of the effective set of interference contours, the machining program is changed in a step 120 such that the laser cutting head 24 always maintains a predetermined minimum distance, typically a few millimeters or a few centimeters, from the interference contours of components 18, 18.2-18.4 already cut free in the machining process, which are stored in the effective set. In order to determine a suitably changed machining program, multiple variants of changed machining programs can be determined and the best variant is selected from these according to a predetermined criterion.

In the example shown, cf. FIG. 4, a travel path 48 (dotted line) of the laser cutting head 24 between the cutting out of the components 18.2 and 18.3 may extend over the already cut free component 18.1 (solid line), and in particular in the region of its interference contour 44 (cf. FIG. 6), to a piercing point 50 in the originally predetermined machining program. There is therefore a risk of the laser cutting head 24 colliding with the tilted component 18.1. The machining program is changed in such a way that this collision is avoided. Various procedures can be considered for this purpose, which can be used individually or in combination depending on the situation.

One possible change to the machining program is to alter the course of the travel path 48 so that it extends past the component 18.1 and its interference contour 44. A travel path 48′ changed in this way is shown as a dotted line in FIG. 4. Alternatively or additionally, the height of the laser cutting head 24 above the sheet-metal plate 16 could be increased during the positioning movement along the travel path 48 or 48′ and/or a pressure of the cutting gas emerging from the nozzle 32 could be reduced.

In order to prevent the tilting of the component 18.1, its position and/or alignment on the sheet-metal plate 16 could be changed. In other words, the nesting plan can be changed. FIG. 4 shows an arrangement of the component 18.1 rotated and displaced in the direction of the axes 26, 28 as dashed, which increases its overlap with the support bars 34.1 and 34.3 (cf. FIGS. 5 and 6). By changing the nesting plan, it is also possible to ensure that cutting lines do not extend along one of the support bars 34.

In addition or instead, a connection 52 (a so-called micro-joint) of the component 18.1 with a scrap skeleton 54 could be inserted during the cutting-out process. This connection 52 initially holds the component 18.1 to the scrap skeleton 54 and is separated after all components 18.1-18.4 have been cut out. In a corresponding manner, positions of connections to the scrap skeleton 54 could be changed depending on the situation and, if necessary, unnecessary connections to the scrap skeleton 54 could also be removed.

It is also conceivable to change the order in which components 18.1-18.4 are cut out. In this regard, it would be possible to cut out the components in the order 18.2, 18.1, 18.3, 18.4 here. In this way, the length of the positioning movements without cutting (cf. travel paths 48, 48′) could also be reduced under certain circumstances.

Sets of interference contours can also be calculated in step 116 for potentially tilting scrap pieces, for example a scrap piece 56 inside of the component 18.3, and included in the effective set in step 118. In order to avoid collisions with tilting scrap pieces 56, the machining program can be changed in step 120 to cut these scrap pieces 56 into smaller pieces that fall safely between the support bars 34. These can then be discharged via the conveyor belt 38 (cf. FIG. 2).

In step 120, positions of piercing points 50 could also be changed in order to avoid piercing processes being performed over support bars 34. This does not directly contribute to collision avoidance in the current cutting process, but it does reduce wear on the support bars 34. The tolerance fields 40 thus remain smaller and fewer interference contours are determined as a result, since the positions of the support bars 34 only vary in tolerance fields of smaller width.

Steps 114, 116, 118 and 120 can be performed at least in part while the workpiece support 12 is being moved from the loading position (cf. FIG. 1) to the machining position (cf. FIG. 2) in a step 121. Preferably, steps 114, 116, 118 and 120 are performed by the control device 20. The control device is programmed accordingly.

Then, in step 122, the components 18.1-18.4 are cut out according to the changed machining program. If steps 114 to 120 have not yet been completed when the machining position is reached, the start of the cutting-out process is delayed until step 120 has been completed.

If, contrary to expectations, a collision should nevertheless occur during the cutting-out process, steps 112 to 120 can be repeated, cf. the dashed arrow in FIG. 7. In order to perform step 112 again, the workpiece support 12 can be moved to the loading position (step 107 is performed again). Before the remaining components are cut out in the next step 122 with the machining program that has been changed again, the workpiece support 12 is moved back into the machining position (step 121 is performed again).

As described above, embodiments of the invention relate to a method for cutting out sheet-metal parts. A sheet-metal plate rests on multiple support bars. Sheet-metal parts which could tilt during the cutting-out process are determined. Account is taken here of which support bars are actually present. A machining program for cutting out the sheet-metal parts is changed in order to prevent a cutting head from colliding with tilted sheet-metal parts. For this purpose, interference contours due to the potentially tilting sheet-metal parts are calculated for various positions of the support bars in an area around their target position. Information relating to the calculated interference contours for the various assumed support bar positions is aggregated in a predefined manner. The changed machining program prevents the cutting head from entering the regions of the aggregated interference contours of sheet-metal parts that have already been cut free during execution of the program.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Laser cutting machine 10
Workpiece support 12
Housing 14
Sheet-metal plate 16
Components 18; 18.1-18.4
Control device 20
Camera 22
Laser cutting head 24
Axes 26, 28, 30
Nozzle 32
Support bars 34; 34.1-34.3
Grid position 36
Conveyor belt 38
Tolerance fields 40
Width 42
Interference contour 44, 44′
Height 46 of the interference contour 44
Envelope contour 47
Travel path 48, 48′
Piercing point 50
Connection 52
Scrap skeleton 54
Scrap piece 56
Specifying 102 a nesting plan
Specifying 104 a machining program
Specifying 106 widths 42 of tolerance fields 40
Moving 107 the workpiece support 12 into a loading position
Placing 108 a sheet-metal plate 16
Acquiring 110 grid positions 36 of the support bars 34
Acquiring 112 a position of the sheet-metal plate 16 on the workpiece support 12
Determining 114 positions of the support bars 34 relative to the sheet-metal plate 16
Calculating 116 sets of interference contours
Determining 118 a set of effective interference contours
Changing 120 the machining program
Moving 121 the workpiece support 12 into a machining position
Cutting out 122 the components 18

1. A method for cutting out components from a sheet-metal plate using a beam cutting machine with a cutting head, wherein the beam cutting machine comprises a workpiece support with multiple support bars for the sheet-metal plate, wherein the support bars are capable of being arranged at predetermined grid positions;
the method comprising:
A) specifying:
i) a nesting plan of the components to be cut out on the sheet-metal plate,
ii) a machining program for controlling the cutting head during the cutting out of the components arranged according to the nesting plan from the sheet-metal plate, and
iii) tolerance fields of a predetermined width for the grid positions of the support bars;
B) acquiring:
i) the grid positions at which the support bars are present, and
ii) a position of the sheet-metal plate arranged on the workpiece support;
C) determining where the support bars are located relative to the sheet-metal plate;
D) calculating sets of interference contours which result from the components of the predetermined nesting plan tilting on the support bars, wherein each respective set of interference contours is calculated for a plurality of the grid positions of the support bars within the tolerance fields;
E) determining a set of effective interference contours from the calculated sets of interference contours;
F) changing the machining program so that a distance between the cutting head and the interference contours of the components already cut free during execution of the changed machining program does not fall below a predetermined minimum distance for the set of effective interference contours; and
G) cutting out the components according to the changed machining program.

2. The method according to claim 1, wherein the grid positions of the support bars and/or the position of the sheet-metal plate are acquired by a camera.

3. The method according to claim 1, wherein the workpiece support is movable between a loading position and a machining position.

4. The method according to claim 3, wherein the grid positions of the support bars and/or the position of the sheet-metal plate are acquired when the workpiece support is in the loading position.

5. The method according to claim 3, wherein steps D), E) and F) are carried out at least in part while the workpiece support is moved from the loading position to the machining position.

6. The method according to claim 5, wherein a start of step G) is delayed after reaching the machining position until steps D) to F) have been completed.

7. The method according to claim 1, wherein in step D) the sets of interference contours are furthermore calculated for different positions of the sheet-metal plate within a predetermined region relative to an acquired position.

8. The method according to claim 1, wherein the set of effective interference contours corresponds to a respective calculated set of interference contours having a largest volume of the interference contours above the sheet-metal plate and/or a maximum height of the interference contours.

9. The method according to claim 1, wherein the set of effective interference contours corresponds to an envelope contour of the interference contours of multiple calculated sets of interference contours.

10. The method according to claim 1, wherein in step F) multiple changed variants of the machining program are determined, and one of the multiple changed variants is selected according to a predetermined criterion.

11. The method according to claim 1, wherein in step F) a sequence in which the components and/or partial contours of the components are cut out is changed.

12. The method according to claim 1, wherein in step F) the course of the travel paths is changed for positioning movements without a cutting operation, and/or
wherein above components that have already been cut free
a distance between the cutting head and the sheet-metal plate is increased, and/or
a cutting gas pressure is reduced.

13. The method according to claim 1, wherein in step F) an additional cutting of scrap pieces is provided for.

14. The method according to claim 1, wherein in step F)
positions of connections of the components provided for in the machining program with respect to a scrap skeleton of the sheet-metal plate are changed, and/or
the connections of the components with respect to the scrap skeleton of the sheet-metal plate provided for in the machining program are removed, and/or
additional connections of the components with respect to the scrap skeleton of the sheet-metal plate are inserted.

15. The method according to claim 1, wherein in step F) the nesting plan of the components on the sheet-metal plate is changed.

16. The method according to claim 1, wherein the machining program is changed in step F) in such a way that piercing processes in a region of the support bars are reduced.

17. The method according to claim 1, wherein, in an event of a collision of the cutting head with the sheet-metal plate, with one of the components or with a scrap piece during execution of step G), steps B)ii) to F) are performed again and then step G) is continued for remaining cutting operations with the machining program changed again.

18. A beam cutting machine with a cutting head, the beam cutting machine comprising:
a workpiece support with multiple support bars for a sheet-metal plate, wherein the support bars are capable of being arranged at predetermined grid positions;
a camera for acquiring the grid positions at which the support bars are present, and for acquiring a position of a sheet-metal plate arranged on the workpiece support; and
a control device for controlling the cutting head,
wherein a nesting plan of components on the sheet-metal plate, a machining program for cutting out the components from the sheet-metal plate, and a width of tolerance fields for the grid positions of the support bars are stored in the control device, and
wherein the control device is configured to carry out the steps B) to G) of a method according to claim 1.
